(19) United States
(12) Patent Application Publication
(10) Pub. No.: US 2023/0304670 A1
(43) Pub. Date: Sep. 28, 2023

(54) FOOD PREPARATION APPARATUS WITH PROTECTION DEVICE AGAINST OVERHEATING

(71) Applicant: Vorwerk & Co. Interholding GmbH, Wuppertal (DE)

(72) Inventors: Sebastian Tietz, Leverkusen (DE); Gereon Feckler, Dormagen (DE); Stefan Kraut-Reinkober, Leverkusen (DE); Wenjie Yan, Düsseldorf (DE); Torsten Lang, Solingen (DE)

(21) Appl. No.: 18/124,524

(22) Filed: Mar. 21, 2023

(30) Foreign Application Priority Data
Mar. 22, 2022 (EP) 22163403.3

(51) Int. Cl. F24C 7/08; H05B 1/02

(52) U.S. Cl. CPC F24C 7/087; H05B 1/0258

(57) ABSTRACT

The present disclosure relates to a food preparation apparatus with a thermistor as a heating device for heating a food by the food preparation apparatus, with a temperature sensor for measuring a real temperature generated by the heating and a protection device which is configured such that it switches off the heating device or at least reduces the heating power of the heating device when a temperature is determined by the temperature sensor, which is above a first predetermined temperature, characterized in that the food preparation apparatus is configured such that a temperature is also determined by means of the thermistor and the protection device is configured such that it also switches off the heating device depending on the determined temperature or at least reduces the heating power of the heating device depending on the determined temperature, which is determined by means of the thermistor.

With little technical effort, it can thus be reliably avoided that the food preparation apparatus can become excessively hot.

### PRIORITY CLAIM

This application claims priority to European Application Serial No. 22163403.3, filed Apr. 22, 2022, which is expressly incorporated by reference herein.

### FIELD OF THE DISCLOSURE

The present disclosure relates to a food preparation apparatus having a thermistor as a heating device for heating a food by the food preparation apparatus. The food preparation apparatus comprises a temperature sensor for measuring a real temperature generated by heating and a protection device for protecting against excessive heating. By real temperature is meant an actually prevailing temperature and not a temperature that has been determined by a measuring device.

### BACKGROUND

Food is regularly warmed or heated for its preparation. This is done, for example, by means of a stove that has at least one heating plate in the form of a hotplate. A hotplate is a plate that can be heated by a heating device.

A thermistor may serve as a heating device. When an electric current flows through the thermistor, the thermistor is warmed up or heated. The electrical resistance of the thermistor changes reproducibly with the real temperature.

Thus, by thermistor is meant an electrical conductor that heats up or warms up when an electrical current flows through the electrical conductor. The magnitude of the electrical resistance depends on the real temperature.

Food preparation apparatuses with thermistor for heating food are known from the publications EP 3 764 739 A1 and EP 3 808 235 A1. The food preparation apparatus known from the publication EP 3 764 739 A1 has a temperature sensor for measuring real temperatures during the preparation of a food. The food preparation apparatus known from the publication EP 3 808 235 A1 uses the electrical resistance of its thermistor to determine the real temperature during the preparation of a food.

The task of the designs discussed in the present disclosure is to create a food preparation apparatus which can avoid overheating with little technical effort.

### SUMMARY

The task of the present disclosure is solved by a food preparation apparatus having the features of the first claim. Further embodiments of the disclosure are given in the dependent claims.

To solve the problem, the disclosed food preparation apparatus comprises a thermistor as a heating device. The food preparation apparatus is able to heat a food by heating the thermistor and thus prepare the food. An electric current flows through the thermistor for heating during operation of the food preparation apparatus. Thus, for example, a cooking chamber of the food preparation apparatus or, for example, a bottom and/or a wall of a food preparation vessel of the food preparation apparatus may be heated. If there is a food in the cooking chamber or in the food preparation vessel, then the food is also heated.

The food preparation apparatus comprises a temperature sensor. The temperature sensor is intended to determine the real temperature generated by the heating process. Ideally, the real temperature and the determined temperature are the same. The temperature sensor may be integrated, for example, in a wall or in a floor of said cooking chamber or said food preparation vessel. For example, the temperature sensor may be located at the thermistor. The temperature sensor may, for example, be located between conductor track sections of the thermistor.

The food preparation apparatus comprises a protection device configured such that it basically switches off the heating device if a temperature is determined by the temperature sensor that is above a first predetermined temperature threshold value. However, it is not excluded that the power of the heating device is only reduced at first. If this measure is not sufficient to avoid a too high real temperature, the heating device can then be switched off completely in a second step. The protection device then also prevents excessively high real temperatures.

The food preparation apparatus is configured such that a temperature is also determined with the thermistor. It is therefore exploited that the electrical resistance of the thermistor depends on the real temperature. The food preparation apparatus has a device to determine the electrical resistance of the thermistor during operation. The determined electrical resistance of the thermistor is then a measure of the determined temperature. The protection device is configured such that it also switches off the heating device depending on the determined temperature or at least reduces the heating power of the heating device depending on the determined temperature. By determined temperature is meant here the temperature determined by means of the thermistor.

The food preparation apparatus thus has a protection device that can provide particularly reliable protection against excessively high real temperatures. The protection device can therefore be configured such that it switches off the heating device or at least reduces the heating power of the heating device if a temperature is determined by the thermistor that is above a second predetermined temperature threshold value.

### BRIEF DESCRIPTIONS OF THE DRAWINGS

The figures show:

FIG. 1: bottom of a food preparation apparatus;

FIG. 2: food processor;

FIG. 3: determined temperature curve in case of undisturbed state;

FIG. 4: determined temperature curve in the case of a highly disturbed state;

FIG. 5: determined temperature curve in the case of a slightly disturbed state;

FIG. 6: determined temperature curve in the case of a disturbed state;

FIG. 7: determined temperature curve in the case of an undisturbed condition with calibration at high real temperature;

FIG. 8: determined temperature curve in the case of a highly disturbed state with calibration at high real temperature;

FIG. 9: determined temperature curve in the case of a slightly disturbed state with calibration at high real temperature;

FIG. 10: determined temperature curve in the case of a disturbed state with calibration at high real temperature;

FIG. 11: flow diagram.

### DETAILED DESCRIPTION

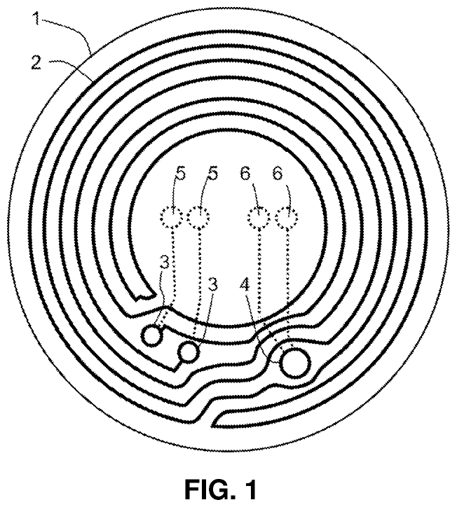

FIG. 1 shows a bottom 1 of a food preparation apparatus. A thermistor 2 is integrated in the bottom 1. The thermistor 2 is formed by an electrical conductor track, which consists for example of copper, aluminum or a suitable alloy. The electrical conductor track runs from a first electrical terminal 3 to a second electrical terminal 3 in such a way that an annular area of the bottom 1 can be heated as uniformly as possible.

The bottom 1 may, for example, consist at least essentially of metal. The thermistor 2 is then located inside the metal and is electrically insulated from the metal of the bottom 1.

There is a temperature sensor 4 integrated in the bottom 1. The temperature sensor 4 is arranged between electrical conductor sections of the thermistor 2.

Electrical connectors 5, 6 can protrude downward from the bottom 1, for example. The two electrical connectors 5 are electrically connected to the electrical terminals 3 of the thermistor. Electrical current can then flow via the electrical connectors 5 to heat the thermistor. The electrical resistance of the thermistor 2 can then be calculated from the applied electrical voltage and the amperage of the flowing electrical current. The electrical resistance can be converted into a determined temperature. Thus, a temperature can be determined by means of the thermistor 2.

The electrical connectors 6 are connected to the temperature sensor 4. If the temperature sensor 4 comprises a temperature-dependent electrical conductor or semiconductor, the electrical resistance of the temperature sensor 4 can be determined via the electrical connectors 6. In the undisturbed state, the determined electrical resistance of the temperature sensor 4 is a measure of the real temperature and can therefore be converted to a determined temperature.

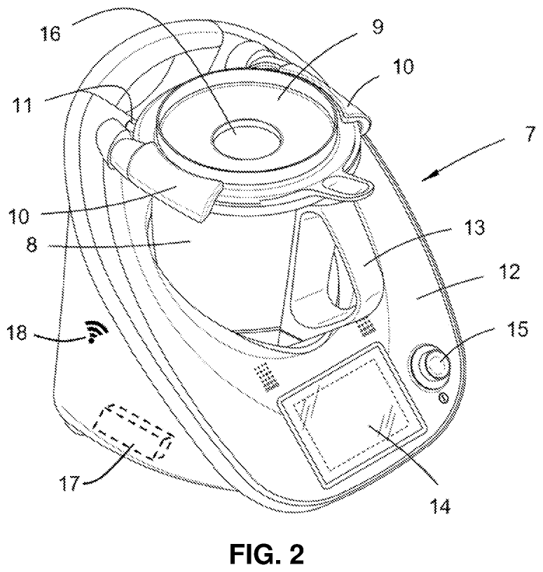

The bottom 1 may be a bottom of a food preparation vessel of a food processor. FIG. 2 shows an example of a food processor 7 with such a food preparation vessel 8. A lid part 9 may be placed on the food preparation vessel 8. The lid part 9 for the food preparation vessel 8 may be locked by arm-like locking elements, i.e. arms 10. The lid part 9 may then be located between the two arms 10. The arms 10 can be rotated about their longitudinal axis in a motorized manner, and thus back and forth between an open position and a locked position. The lid part 9 may have a sensor, namely a rocker arm 11 of an electric switch, which can be pressed down by the lid part 9 and thus triggered. Proper locking can thus be detected. The arm-like locking elements 10 and the rocker arm 11 may be attached to a base part 12 of the food processor 7. For example, the food preparation vessel 8 is inserted into the base part 12 and can be removed from the base part 12. In order to be able to remove the food preparation vessel 8, the food preparation vessel 8 may comprise a handle 13. The base part 12 may comprise a touch-sensitive display 14 and/or a rotary switch 15 for operation. The rotary switch 15 may be rotated and pressed, for example. Touch display 14 and rotary switch 15 may thus be operating elements of the food processor 7. The lid part 9 may centrally comprise an opening 16 that may be closed, for example, with a vessel-like closure.

A control unit 17 may be located in the base part 12. Data can be entered into the control unit 17 via the operating elements 14 and 15. A radio unit 18 may be located in the base part 12, via which data can be sent and/or received wirelessly. Via the radio unit 18, the control unit 17 can access an externally stored recipe, for example. Subsequently, the control unit 17 can control the preparation of a food using the recipe. However, such a recipe can also be stored internally.

In the food preparation vessel 8, a cutting tool may be located that can be driven by a motor. The motor may be located in the base part 12. There is then a feedthrough in the bottom of the food preparation vessel 8, through which the motor can be connected to the cutting tool in a rotationally fixed manner. The thermistor 2 may then be located around the feedthrough. The thermistor 2 in the base of the food preparation vessel 8 can be electrically connected via connectors 5 to the base part 12 for heating. The heating can be controlled via the control unit 17. Furthermore, a temperature of the thermistor 2 can be determined by means of the control unit 17. The temperature sensor 4 can be electrically connected to the base part 12 via connectors 6 for temperature determination. A temperature of the temperature sensor 4 can be determined by means of the control unit 17.

In order to be able to determine temperatures with the thermistor 2, this must be calibrated beforehand. Calibration of the thermistor can be performed recurrently by means of the temperature sensor 4. For example, calibration is performed in an automated manner whenever the food preparation vessel 8 has been inserted into the base part 12 of the food processor 7. For example, calibration is performed in an automated manner whenever the food processor is switched on. This assumes that the food preparation vessel 8 is already inserted into the base part 12. In order to calibrate the thermistor, for example, the initial resistance R₀ of the thermistor 2 is determined at an initial temperature T₀ determined by the temperature sensor 4. From these initial values, a temperature T_{PTC} can then be determined by means of the thermistor using the equation R(T_{PTC})=R₀·(1+TCR·(T_{PTC}−T₀)), wherein R(T_{PTC}) is the temperature-dependent resistance of thermistor 2 and TCR is the resistance slope value of thermistor 2. Thus, if the thermistor 2 has been calibrated and a resistance R of the thermistor 2 is subsequently determined, the control unit 17 can calculate an associated determined temperature T_{PTC}.

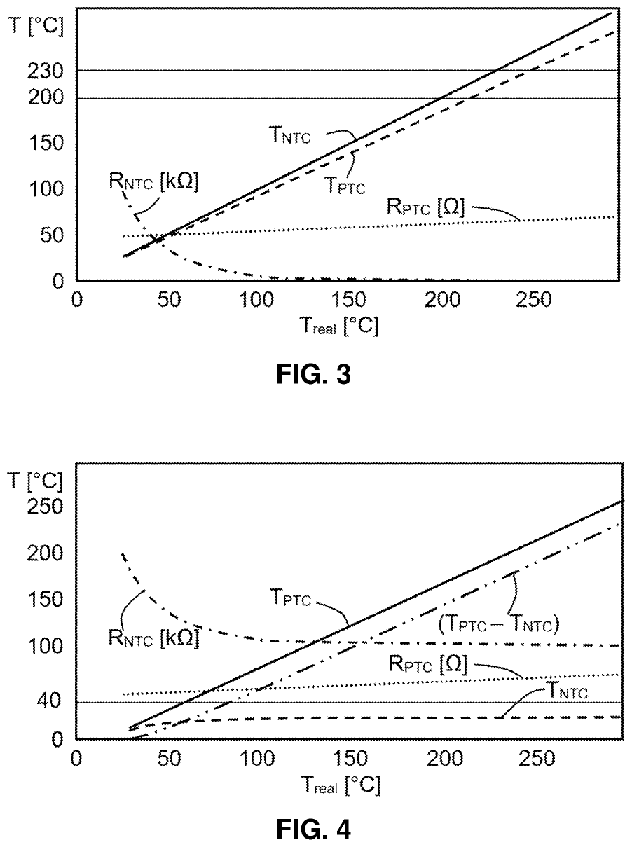

However, a temperature sensor 4 that is also to be used recurrently for calibration can be disturbed and thus damaged, for example, by contamination. Against this background, the following FIGS. 3 to 10 refer, among other things, to disturbances and associated damage to the temperature sensor 4 in the event that the temperature sensor comprises an NTC thermistor whose electrical resistance decreases with increasing temperatures, namely according to an exponential or at least approximately exponential curve.

The thermistor 2 is a PTC thermistor, that is, a PTC resistor whose resistance increases linearly or at least approximately linearly with increasing real temperature. It may also be sufficient that there is a relevant temperature range and within the temperature range the resistance increases linearly or at least approximately linearly with increasing temperature. The relevant temperature range corresponds to the temperature range that the food preparation apparatus can cover for preparing a food.

FIG. 3 refers to an undisturbed state. In FIG. 3, temperatures determined by thermistor 2 and temperature sensor 4 are plotted against the prevailing real temperature Tᵣₑₐₗ. T_{NTC} shows the temperature determined by the temperature sensor 4. T_{PTC} shows the temperature determined by thermistor 2.

The determined temperatures T_{PTC} and T_{NTC} correspond to the real temperature Tᵣₑₐₗ. Thermistor 2 and temperature sensor 4 therefore operate disturbance-free and correctly.

FIG. 3 also shows the curve of the resistors depending on the real temperature Tᵣₑₐₗ. R_{PTC} shows the temperature-dependent curve of the resistance of thermistor 2. This increases with the real temperature. Thermistor 2 is therefore a PTC thermistor. R_{NTC} shows the temperature-dependent curve of the resistance of the temperature sensor 4. This decreases with the real temperature. Temperature sensor 4 is an NTC thermistor and therefore an NTC resistor.

The determined temperature difference T_{PTC}−T_{NTC} always remains below a predetermined value of 40° C. or 40 K, for example. The control unit 17 therefore switches off the heating device 2 only if a temperature T_{PTC} of, for example, more than 230° C. is determined by means of the thermistor 2 or if a temperature T_{NTC} of, for example, more than 200° C. is determined by means of the temperature sensor 4. The protection device is thus implemented by the control unit 17.

The thermistor 2 can be properly calibrated by the temperature sensor 4 at a real temperature such as prevails in living spaces, for example at a prevailing real temperature Tᵣₑₐₗ of 25° C.

FIG. 4 shows the case where the temperature sensor 4 is severely disturbed and thus severely damaged. Its resistance R_{NTC} is much higher compared to the resistance R_{NTC} shown in FIG. 3. For example, the resistance R_{NTC} is 100 kΩ too high at each real temperature due to the disturbance. Therefore, only determined temperatures of less than 30° C. are ever determined by the temperature sensor 4 regardless of the real temperature Tᵣₑₐₗ. Therefore, if the real temperature Tᵣₑₐₗ increases, the temperature difference T_{PTC}−T_{NTC} increases, for example, essentially linearly. If the temperature difference T_{PTC}−T_{NTC} exceeds a preset value of 40° C. or 40 K, for example, the protection device 17 switches off the heating device 2 completely.

The thermistor 2 can nevertheless be calibrated sufficiently properly by the temperature sensor 4 at a real temperature such as prevails in living spaces, for example at a prevailing real temperature Tᵣₑₐₗ of 25° C. Calibration by a severely disturbed temperature sensor 4 at normal real room temperatures therefore does not result in the protection device 17 becoming ineffective.

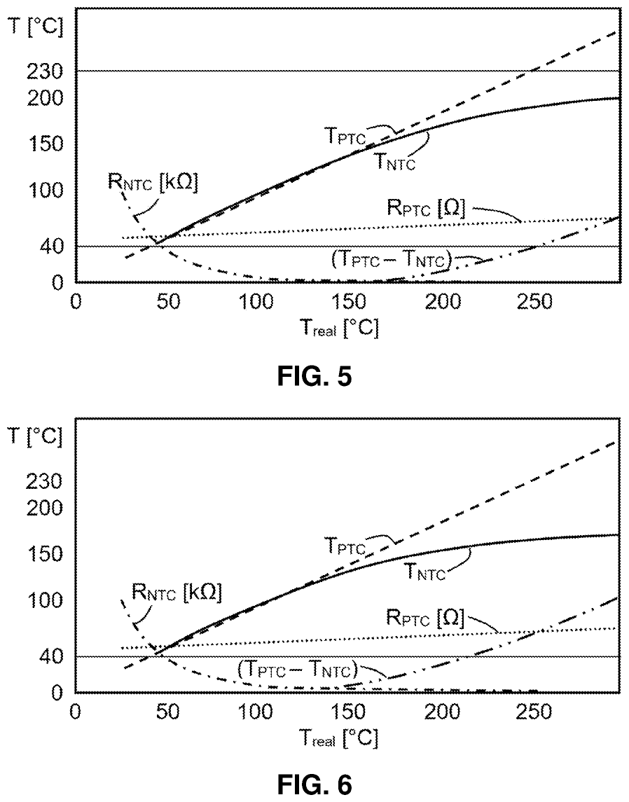

FIG. 5 shows the case where the temperature sensor 4 is slightly damaged. Its resistance R_{NTC} is slightly higher compared to the resistance R_{NTC} shown in FIG. 3. For example, the resistance R_{NTC} is 0.485 kΩ too high due to the disturbance. Initially, therefore, temperatures are determined by the temperature sensor 4 that correspond to the real temperature Tᵣₑₐₗ. If real temperatures Tᵣₑₐₗ of, for example, more than 150° C. are reached, the slight damage becomes noticeable. Too low temperatures are determined by the temperature sensor 4. The deviation from the real temperature increases more and more as the real temperature Tᵣₑₐₗ increases. The temperature difference T_{PTC}−T_{NTC} then increases. For example, if the temperature difference T_{PTC}−T_{NTC} exceeds a preset value of 40° C. or 40 K, the protection device 17 switches off the heating device 2, in some cases completely. The temperature difference T_{PTC}−T_{NTC} of 40° C. is reached, for example, when a real temperature of about 230° C. is reached by the thermistor 2. In such cases, the heating device can therefore also be switched off because the temperature determined by thermistor 2 is too high. In the case of a minor disturbance, as shown in FIG. 5, a switching-off of the heating device can therefore occur for two different reasons.

The thermistor 2 can be properly calibrated by the temperature sensor at a real room temperature such as prevails in living spaces, for example, at a prevailing real temperature Tᵣₑₐₗ of 25° C. Thus, calibration by a slightly disturbed temperature sensor 4 at usual real room temperatures does not result in the protection device 17 becoming ineffective.

FIG. 6 shows the case where the temperature sensor 4 is slightly more damaged compared to the case shown in FIG. 5. Its resistance R_{NTC} is slightly higher compared to the resistance R_{NTC} shown in the FIG. 5. For example, the resistance R_{NTC} is 1 kΩ too high compared to the undamaged state due to the disturbance or damage. Initially, temperatures are determined by the temperature sensor 4 as in the case of FIG. 5, which correspond to the real temperature Tᵣₑₐₗ. However, a deviation occurs earlier compared to the case shown in FIG. 5. If real temperatures Tᵣₑₐₗ of, for example, more than 120° C. are reached, the damage becomes noticeable. Too low temperatures are determined by the temperature sensor 4. The deviation from the real temperature Tᵣₑₐₗ increases more and more with increasing real temperatures Tᵣₑₐₗ as in the case shown in FIG. 5. The temperature difference T_{PTC}−T_{NTC} then increases. For example, if the temperature difference T_{PTC}−T_{NTC} exceeds a preset value of 40° C. or 40 K, the protection device 17 switches off the heating device 2, in some cases completely. The temperature difference T_{PTC}−T_{NTC} of 40° C. is reached much earlier before a real temperature of about 230° C. is reached by the thermistor 2. A switching-off of the power supply to the thermistor 2 can therefore not take place for the reason that a too high temperature was determined by the thermistor 2 in such cases.

The thermistor 2 can be properly calibrated by the temperature sensor at a real temperature such as prevails in living spaces, for example at a prevailing real temperature Tᵣₑₐₗ of 25° C. Thus, calibration by the disturbed temperature sensor 4 at usual real room temperatures again does not result in the protection device 17 becoming ineffective.

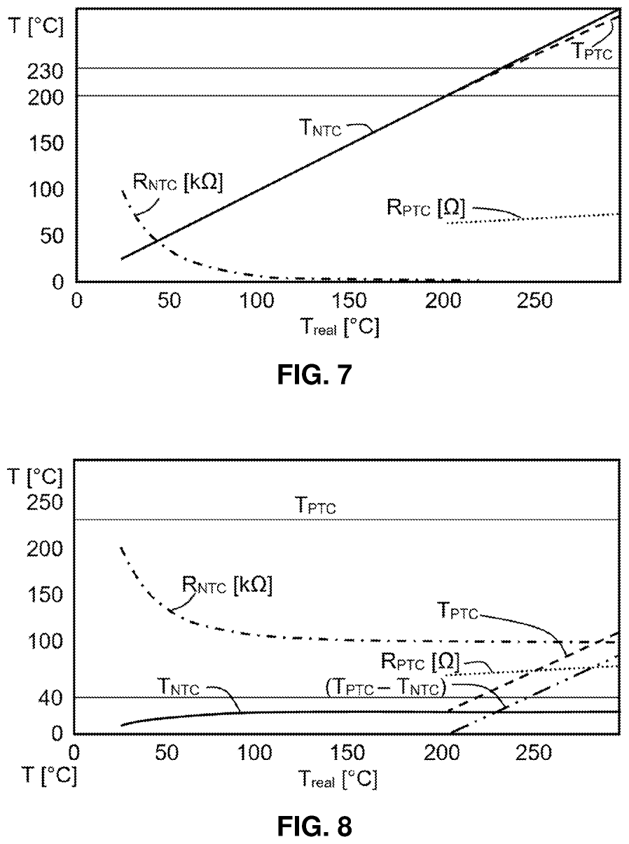

FIG. 7 refers to an undisturbed state. A calibration of the thermistor 2 by means of the temperature sensor 4 takes place at high real temperatures, for example at 200° C. The determined temperature T_{PTC} as well as the corresponding resistance R_{PTC} are therefore shown from temperatures of 200° C. A switching-off of the heating device and thus a power supply to the thermistor 2 can take place as soon as too high temperatures of more than 200° C. or 230° C. are determined by the temperature sensor 4 or by the thermistor 2. Proper calibration of the thermistor 2 is possible at a prevailing real temperature Tᵣₑₐₗ of 200° C., for example.

FIG. 8 shows the case where the temperature sensor 4 is severely damaged and its resistance R_{NTC} is therefore too high by 100 kΩ. The temperature sensor 4 will therefore only determine temperatures that are significantly below 50° C. If, for example, the real temperature Tᵣₑₐₗ is 200° C. and the thermistor 2 is then calibrated, temperatures T_{PTC} are determined by means of the thermistor 2 after calibration which are considerably below the real temperature Tᵣₑₐₗ. It is therefore no longer possible to determine a temperature T_{NTC} or T_{PTC} which corresponds to the prevailing real temperature Tᵣₑₐₗ. Despite the faulty calibration, the protection device 17 switches off the power supply to the thermistor 2 as soon as an excessively high real temperature Tᵣₑₐₗ is reached, because the difference T_{PTC}−T_{NTC} then exceeds the value of 40° C. Even a serious damage of the temperature sensor 4 and a very faulty calibration of the thermistor 2 does not have the consequence that the protection device 17 is disabled.

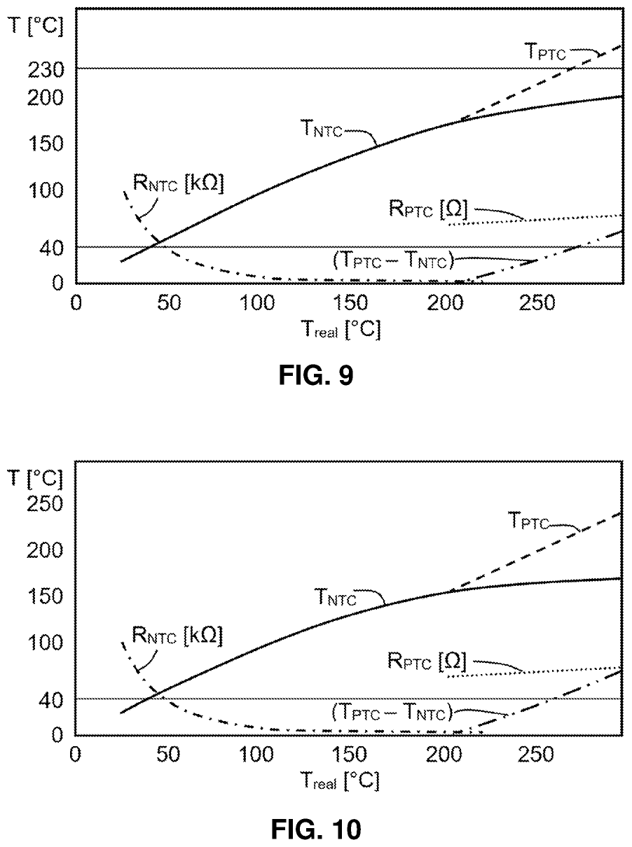

FIG. 9 shows the case where the temperature sensor 4 is slightly damaged. Its resistance R_{NTC} is slightly higher compared to the resistance R_{NTC} shown in FIG. 3. For example, the resistance R_{NTC} is always 0.485 kΩ too high due to the disturbance. The thermistor 2 is calibrated at a prevailing real temperature Tᵣₑₐₗ of 200° C., for example. As a result, at high real temperatures, for example above 200° C., only too low temperatures T_{PTC} and T_{NTC} are determined. Determining the temperature by means of thermistor 2 and temperature sensor 4 at high real temperatures results in values that are several 10° C. too low. Nevertheless, the protection device 17 is able to switch off the supply of current to the thermistor 2 before a real temperature Tᵣₑₐₗ of, for example, 295° C. is reached. For either the protection device 17 switches off as soon as a temperature T_{PTC} of more than 230° C. is determined by the thermistor 2, or the protection device 17 switches off because the temperature difference T_{PTC}−T_{NTC} exceeds the value 40° C. A temperature difference T_{PTC}−T_{NTC} of more than 40° C. is reached when the real temperature is between 260° C. and 280° C. Thus, even if the temperature sensor 4 is slightly damaged, it is achieved that a real temperature close to 300° C., such as 295° C., cannot be reached.

FIG. 10 refers to such a disturbance or damage of the temperature sensor 4 that its resistance is too high by 1 kΩ compared to the undisturbed or not damaged state. It is true that in the range of high real temperatures it is not possible to determine the real temperature Tᵣₑₐₗ with satisfactory accuracy. Nevertheless, it is ensured that real temperatures of approximately 300° C. cannot be reached. The protection device 17 interrupts the power supply to the thermistor 2 beforehand due to an excessive temperature difference T_{PTC}−T_{NTC} of more than 40° C., for example.

An exemplary procedure is as follows.

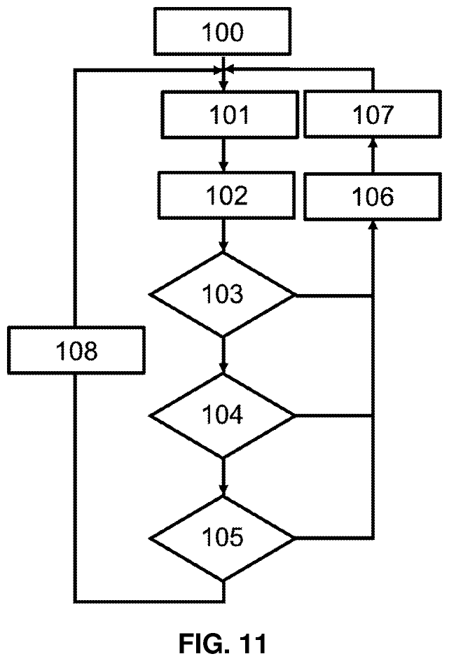

First, a thermistor 2 is calibrated, for example a PTC heating conductor serving as a thermistor. The calibration can be performed as described in the food preparation apparatus or in production. Such a calibration is indicated by a step 100 in the flow chart of FIG. 11.

During ongoing heating operation of the food preparation apparatus, temperatures are determined, for example, by evaluating resistances. On the one hand, the resistance of the thermistor 2 is then evaluated according to step 101, for example the resistance of a PTC heating conductor. On the other hand, the resistance of the temperature sensor 4 is evaluated according to step 102, for example the resistance of an NTC conductor. The resistance evaluation can be performed within the food preparation apparatus.

During the ongoing heating operation, it is checked whether
a temperature is determined by the temperature sensor 4 according to step 103 which lies below the first predetermined temperature threshold value,
a temperature is determined by the thermistor 2 according to step 104 which is below the second predetermined temperature threshold value, and
the temperature difference between the temperature determined by the temperature sensor 4 and the temperature determined by the thermistor 2 according to step 105 is smaller than a predetermined temperature difference.

If none of the three switch-off criteria is fulfilled, the flow chart is run through again from step 101. The optional step 108 is omitted in this case.

If one of the three switch-off criteria is met, the heating device of the food preparation apparatus is switched off according to step 106. The food preparation apparatus may then output an error message visually and/or audibly indicating that the heating device is not restarted in an automated manner.

Before the heating device can be restarted, the user must first acknowledge the error according to step 107, for example by operating a key of the food preparation apparatus. Subsequently, the heating operation can only be restarted by the user if all switch-off criteria are not met. Only then can the heating device be switched on again by the optional step according to step 108.

The food preparation apparatus as described in this paper has a protection device that can provide particularly reliable protection against excessively high real temperatures. The protection device can therefore be configured such that it switches off the heating device or at least reduces the heating power of the heating device if a temperature is determined by the thermistor that is above a second predetermined temperature threshold value.

The first predetermined temperature threshold value for the temperature sensor is preferably smaller than the second predetermined temperature threshold value for the thermistor. In principle, a temperature sensor is more suitable for determining a real temperature than a thermistor. After all, the thermistor is primarily intended to heat. A thermistor is designed to be optimized accordingly. In contrast, the temperature sensor is basically optimized so that it can determine a real temperature particularly quickly and accurately. If the first predetermined temperature threshold value is smaller than the second predetermined temperature threshold value, then it is achieved by this that the protection device switches off usually only in response to the temperature measuring device which is most suitable for the measurement of a temperature.

When a food is cooked, the real temperature is about 100° C. In a cooking pot or in a preparation vessel comparable thereto, real temperatures of more than 100° C. can also be reached. In such preparation vessels, real temperatures of 200° C. are generally not provided for preparing a food. It is therefore expedient that any predetermined temperature threshold value is significantly more than 100° C., for example at least 180° C. or at least 200° C. A reasonable selection therefore consists, for example, in the first predetermined temperature threshold value being at least 180° C., for example 200° C. The second predetermined temperature threshold value may usefully be at least 210° C., such as 230° C. Since for almost all household cooking appliances the provided real temperatures are less than 230° C., it is reasonable to provide 260° C. as an upper limit for the predetermined temperature threshold values. Therefore, 220° C. can be provided as the upper limit for the first predetermined temperature threshold value. Therefore, 250° C. can be provided as the upper limit for the second predetermined temperature threshold value. These upper limits are particularly useful for food preparation apparatuses that comprise a cooking pot or a food preparation vessel comparable thereto. An example of a food preparation vessel comparable thereto is a food preparation vessel of a food processor, which is capable of mixing and/or chopping as well as heating a food and/or a foodstuff present in the food preparation vessel.

The protection device may be configured such that it switches off the heating device or at least reduces the heating power of the heating device when the temperature difference between the determined temperature determined by the temperature sensor and the determined temperature determined by the thermistor is greater than a predetermined temperature difference. By this embodiment, the proper determination of temperatures is monitored. Thus, a very high reliability is provided. If one of the two temperature determinations is disturbed, this becomes noticeable by a correspondingly large temperature difference. A disturbance of a temperature determination determined in such a manner has then the consequence that the heating device is switched off or the heating power is at least reduced. Immediate switch-off can be implemented for reliability reasons.

A predetermined temperature difference may, for example, be at least 20° C. or at least 30° C. in order to be able to reliably detect relevant disturbances of temperature measurements. A predetermined temperature difference should not exceed 60° C. for reliability reasons. A predetermined temperature difference can be, for example, 35° C. to 45° C. A predetermined temperature difference can be 40° C. or 40 K, for example.

Particularly high reliability is achieved if use is made of all of the above criteria or possibilities. It is therefore possible that the heating device is switched off when a temperature is determined by the temperature sensor that is above the first predetermined temperature threshold value. The heating device is switched off when a temperature is determined by the thermistor that is above the second predetermined temperature threshold value. The heating device is switched off when the temperature difference between the temperature determined by the temperature sensor and the temperature determined by the thermistor is greater than a predetermined temperature difference.

It is the goal that the protection device reliably prevents an excessively high real temperature from being reached. An excessively high real temperature can be, for example, 300° C. The protection device is then configured such that it interrupts the supply of current to the thermistor before 295° C. is reached, for example. This is a particularly reliable way of preventing a real temperature of 300° C. from being reached. First and second predetermined temperature threshold values as well as the predetermined temperature difference are therefore selected in such a way that even in the event of a disturbance (fault) of the temperature sensor or the thermistor, a power supply to the thermistor is switched off so that it is switched off at the latest before a real temperature of 295° C. is reached.

The food preparation apparatus may be further configured such that, after the heating device has been switched off by the protection device, the heating device can only be switched on again if
a temperature is determined by the temperature sensor which is below the first predetermined temperature threshold value,
a temperature is determined by the thermistor which is below the second predetermined temperature threshold value, and
the temperature difference between the temperature determined by the temperature sensor and the temperature determined by the thermistor is less than a predetermined temperature difference.

The temperature sensor is able to determine a temperature locally such that this determined temperature can then be further used to determine the real temperature in the food preparation vessel as accurately as possible.

The food preparation apparatus may comprise a control unit which is configured such that the heating by the heating device can be controlled depending on the determined temperature determined by the temperature sensor. A target temperature can be set to be reached. The control unit can then control the heating device so that the set target temperature is reached and maintained. Setting a desired target temperature can be done, for example, manually via an input device of the food preparation apparatus. The setting of a desired target temperature can, for example, be performed via an input device of the food preparation apparatus in a manner controlled by the control unit, for example on the basis of an electronically stored recipe that can be accessed by the control unit. The recipe then contains corresponding information that enables the setting.

The thermistor may be a PTC thermistor. Common metals can then be used in order to keep the technical effort for producing the heating device low. For example, the PTC thermistor may be manufactured based on copper, aluminum or iron.

The temperature sensor may comprise an NTC thermistor as a sensor, especially if the thermistor of the heating device is a PTC thermistor. It is thus ensured that different and differently acting materials are used to determine temperatures, which can further improve reliability. A semiconductor can be used as the NTC thermistor. Compound semiconductors or corresponding metallic alloys can also be considered. The electrical resistance of the NTC thermistor is then measured and the temperature is determined on the basis of the measured value, which ideally corresponds to the real temperature.

The electrical resistance of the PTC thermistor preferably increases linearly or at least essentially linearly, i.e. approximately linearly, with the real temperature. The electrical resistance of the NTC thermistor preferably decreases non-linearly with increasing real temperature. Preferably, the electrical resistance of the NTC thermistor initially decreases steeply with increasing real temperature, at least from 20° C. onwards. Towards higher real temperatures, the electrical resistance of the NTC thermistor decreases only slightly and thus leads to a flat curve. Overall, the curve of the electrical resistance in dependence on the real temperature is then arc-shaped. The electrical resistance of the NTC thermistor therefore decreases, for example, with the real temperature according to an exponential curve or at least approximately according to an exponential curve. It is thus achieved that the two resistances behave very oppositely in dependence on the real temperature. This can improve the reliability, because the protection device switches off reliably even in case of a damaged temperature sensor or damaged thermistor. This is even true if the thermistor has been calibrated by means of the temperature sensor.

The food preparation apparatus may comprise a calibration device which is configured such that the thermistor of the heating device can be calibrated. This embodiment of the disclosure is particularly useful when the kitchen appliance comprises a base part into which a food preparation vessel with the thermistor integrated therein can be inserted. Since in this case a food preparation vessel can be replaced at any time, it is useful to calibrate the respective thermistor, for example, as soon as a food preparation vessel is inserted into the base part and/or the food preparation apparatus is switched on. The latter basically requires that the food preparation vessel is inserted into the base part. Through calibration, it is determined at which electrical resistance of the thermistor which real temperature prevails. For the calibration it can be sufficient to determine a temperature of the thermistor and the resistance that the thermistor has at this determined temperature.

The calibration device can be configured such that the calibration device calibrates the thermistor by means of the temperature sensor. Thus, the electrical resistance of the thermistor is measured for calibration and an associated temperature is determined using the temperature sensor. The determined temperature corresponds to the real temperature of the thermistor in the disturbance-free state. However, it is also possible to use a different temperature sensor for the calibration.

In particular, the disclosure relates to a food preparation apparatus described above, i.e. a food preparation apparatus comprising a base part and a food preparation vessel which can be inserted, for example, into a recess of the base part. An electrical connection between the base part and the food preparation vessel may have been produced by inserting. In principle, there is then no further mechanical fastening between the base part and the food preparation vessel. However, it is possible that a lid part can be placed on the food preparation vessel, that the lid part can then be locked and then there is an additional mechanical fastening between the base part and the food preparation vessel.

There may be a control unit in the base part, via which the power supply to the thermistor integrated in the food preparation vessel and thus the heating can be controlled. The power supply may be provided via the electrical connection mentioned above. The temperature sensor may also be integrated into the food preparation vessel. In this embodiment, the control unit can control the heating of the thermistor and thus the heating of the food preparation vessel depending on the temperature determined by the temperature sensor. The electrical connection may comprise electrical conductors for the power supply to the thermistor on the one hand and electrical conductors for reading the temperature sensor on the other hand.

Information can be stored in the food preparation vessel by which a resistance of the thermistor can be converted into a determined temperature. For example, a curve indicating the electrical resistance of the thermistor depending on determined temperatures can be stored as information. However, it may also be sufficient that an electrical resistance and an associated determined temperature are indicated.

The food preparation vessel may comprise, for example, a barcode, a radio-frequency identification transponder (RFID), or other electronics by which the information is or may be stored. The base part is then configured such that it can read the information. For example, the base part may comprise a barcode reader or RFID reader for reading the information. Subsequently, the control unit can convert a measured resistance of the thermistor into a determined temperature.

Thus, there is the possibility to perform calibration already during manufacturing of the heater or the cooking vessels (e.g. in the final inspection) and to store the values in an information technology retrievable form. The values can thus be stored retrievably by electronics, RFID tag, barcode, etc. as previously explained. Electronics, RFID tag, barcode, etc. may be arranged on or in the food preparation vessel.

The food preparation apparatus with the base part and the insertable food preparation vessel may be a food processor with a mixing tool, with which a food can be mixed and/or chopped in a food preparation vessel of the food processor.

The food preparation apparatus may comprise a pot or pan with an integrated thermistor.

The food preparation apparatus may comprise more than one thermistor. For example, there may be two thermistors for heating the food preparation vessel. The thermistors may be integrated into a wall of the food preparation vessel. The thermistors may be present in or at the bottom of the food preparation vessel. A first thermistor may be located in a first half of the bottom. A second thermistor may be located in a second half of the bottom. A first thermistor may be located in a first plane of the bottom. A second thermistor may be located in a second plane of the bottom that is above or below the first plane. Thermistors may thus be arranged one above the other. A first thermistor may extend parallel to a second thermistor. A first thermistor or a portion of a first thermistor may be disposed in a gap of a second thermistor and/or vice versa. A portion of a first thermistor may be present in the bottom and another portion of the first thermistor may be present in a side wall of the cooking vessel. A portion of a second thermistor may be present in the bottom and another portion of the second thermistor may be present in a side wall of the cooking vessel.

Thus, the heating device may comprise more than one thermistor. If several thermistors are present, they may be controlled together or separately. For example, if several thermistors are present, they may be switched off separately.

The protection device may be configured such that it reduces the heating power of the heating device by having the protection device switch off only one of a plurality of thermistors.

A first thermistor may consist of a first material and a second thermistor may consist of a second different material to further improve reliability.

The protection device may be configured such that it switches off the heating device or at least reduces the heating power of the heating device when a temperature is determined by a second thermistor that is above a third predetermined temperature threshold value different from the first and second predetermined temperature threshold values. The protection device may be configured such that it averages determined temperatures determined by a plurality of thermistors. The protection device may be configured such that it switches off the heating device or at least reduces the heating power of the heating device when the average value determined is above the second predetermined temperature threshold value. Thus, the two or more thermistors may be evaluated separately or in combination, which may result in a switching-off. Two or more thermistors can thus be part of the protection device.

A temperature sensor may be assigned to each thermistor. Several temperature sensors may then be part of the protection device. A faulty temperature determination by one of the thermistors or by one of the temperature sensors can then result in only one thermistor being switched off, namely the thermistor with the assigned temperature sensor at which the disturbance was detected. However, both thermistors can also be switched off, even if a disturbance only affects one thermistor and the associated temperature sensor. However, it is also possible to switch off only the thermistor affected by the disturbance first and then switch off the other thermistor after a time delay. A time-delayed switching off can be useful to be able to finish a food preparation step properly.

The protection device may be configured such that it switches off the heating device or at least reduces the heating power of the heating device if a temperature is determined by a second temperature sensor that is above a fourth predetermined temperature threshold value. The fourth predetermined temperature threshold value then differs from the other predetermined temperature threshold values.

The protection device may be configured such that it averages determined temperatures determined by a plurality of temperature sensors. The protection device may be configured such that it switches off the heating device or reduces the heating power of the heating device at least if the average value formed is above the first predetermined temperature threshold value. The two or more temperature sensors can thus be evaluated separately or in combination, which can lead to a switching-off.

The protection device may be configured such that it switches off the heating device or reduces the heating power of the heating device at least also when the temperature difference between the determined temperature determined by a second temperature sensor and the determined temperature determined by a second thermistor is smaller than a predetermined temperature difference.

If two thermistors are present, only one temperature sensor may be positioned between the two thermistors. Thus, there may then be only one temperature sensor associated with both thermistors and thus providing a temperature value for both thermistors. The protection device can then be configured such that it switches the heating device off or at least reduces the heating power of the heating device if the temperature difference between the determined temperature determined by the one temperature sensor and the determined temperature determined by the first or the second thermistor is smaller than a predetermined temperature difference.

The present disclosure makes it possible to very reliably avoid excessively high temperatures in a kitchen appliance without having to provide dedicated components such as a fuse or bimetal switch.

For example, if the temperature sensor comprises an NTC thermistor and thus an NTC resistor (Negative Temperature Coefficient Thermistor), the temperature sensor may be disturbed due to a short circuit of the NTC resistor. The resistance is then almost 0Ω. A resistance of almost 0Ω is interpreted as a very high determined temperature. The protection device then switches off the heating device, in some cases completely.

The circuit of the NTC resistor may be disturbed and therefore open. The electrical resistance can thus tend to infinity. A very high resistance is interpreted as a very low determined temperature. The difference between the determined temperature determined by the thermistor and the determined temperature determined by the temperature sensor then becomes very large. The protection device then switches off the heating device, in some cases completely.

Contacts of the temperature sensor as well as of the NTC resistor may become contaminated, for example by food. This can result in an additional resistance connected in parallel. An electrical resistance that is too low is then measured. Contamination can also lead to an additional resistor connected in series. An electrical resistance that is too high is then measured. Also a disturbance of the temperature sensor due to contamination can be detected, because the temperature difference between the determined temperature, which is determined by the thermistor, and the determined temperature, which is determined by the temperature sensor, will become too large. The protection device then switches off the heating device, in some cases completely.

1. A food preparation apparatus comprising
a thermistor as a heating device for heating a food by means of the food preparation apparatus,
a temperature sensor for measuring a real temperature generated by the heating,
a protection device which is configured such that it switches off the heating device or at least reduces the heating power of the heating device if a temperature is determined by the temperature sensor which lies above a first predetermined temperature threshold value, wherein the food preparation apparatus is configured such that a temperature is also determined by means of the thermistor, and the protective device is configured such that it also switches off the heating device depending on the determined temperature or at least reduces the heating power of the heating device depending on the determined temperature, which is determined by means of the thermistor.

2. The food preparation device of claim 1, wherein the protection device is configured such that it switches off the heating device or at least reduces the heating power of the heating device if a temperature is determined by the thermistor which is above a second predetermined temperature threshold value.

3. The food preparation device of claim 2, wherein the first predetermined temperature threshold value is smaller than the second predetermined temperature threshold value.

4. The food preparation device of claim 1, wherein the first predetermined temperature threshold value is between 180° C. and 220° C.

5. The food preparation device of claim 2, wherein the second predetermined temperature threshold value is between 210° C. and 250° C.

6. The food preparation device of claim 1, wherein the protection device is configured such that it switches off the heating device or at least reduces the heating power of the heating device when the temperature difference between the determined temperature determined by the temperature sensor and the determined temperature determined by the thermistor is greater than a predetermined temperature difference.

7. The food preparation device of claim 6, wherein the predetermined temperature difference is between 30° C. and 60° C.

8. The food preparation device of claim 1, wherein the food preparation device is configured such that, after the heating device has been switched off by the protection device, the heating device can only be switched on again if
a temperature is determined by the temperature sensor which is below the first predetermined temperature threshold value,
a temperature is determined by the thermistor which is below the second predetermined temperature threshold value, and
the temperature difference between the temperature determined by the temperature sensor and the temperature determined by the thermistor is smaller than a predetermined temperature difference.

9. The food preparation device of claim 1, wherein the food preparation apparatus comprises a control unit which is configured such that the heating by the heating device is controlled depending on the temperature determined by the temperature sensor.

10. The food preparation device of claim 1, wherein the thermistor is a PTC thermistor and the resistance of the PTC thermistor increases linearly or at least approximately linearly with the temperature.

11. The food preparation device of claim 1, wherein the temperature sensor comprises a NTC thermistor as a sensor and the resistance of the NTC thermistor is exponential depending on the temperature.

12. The food preparation device of claim 1, wherein the food preparation apparatus comprises a calibration device which is configured such that the thermistor is calibrated.

13. The food preparation device of claim 12, wherein the calibration device is configured such that the calibration device calibrates the thermistor by means of the temperature sensor.

14. The food preparation device of claim 1, wherein the food preparation apparatus comprises a base part with a control unit and a food preparation vessel with the thermistor and the temperature sensor, wherein the food preparation vessel can be inserted into the base part, wherein the control unit is configured such that it is able to control the heating of the thermistor and thus the heating of the food preparation vessel depending on the temperature determined by the temperature sensor.

15. The food preparation device of claim 14, wherein information is stored in the food preparation vessel by which a resistance of the thermistor can be converted into a determined temperature.

16. The food preparation device of claim 4, wherein the protection device is configured such that it switches off the heating device or at least reduces the heating power of the heating device if a temperature is determined by the thermistor which is above a second predetermined temperature threshold value, and wherein the second predetermined temperature threshold value is between 210° C. and 250° C.

17. The food preparation device of claim 16, wherein the protection device is configured such that it switches off the heating device or at least reduces the heating power of the heating device when the temperature difference between the determined temperature determined by the temperature sensor and the determined temperature determined by the thermistor is greater than a predetermined temperature difference.

18. The food preparation device of claim 17, wherein the predetermined temperature difference is between 30° C. and 60° C.

19. A food preparation apparatus comprising
a thermistor as a heating device for heating a food by means of the food preparation apparatus,
a temperature sensor for measuring a real temperature generated by the heating, and
a control unit coupled to the thermistor and the temperature sensor such that it is able to control the heating of the thermistor and to switch off or reduce power to the thermistor in response to at least one of (a) receipt of a temperature received from the temperature sensor which lies above a first predetermined temperature threshold value and (b) receipt of a temperature received from the thermistor which lies above a second predetermined temperature threshold value, different from the first predetermined threshold value.

20. The food preparation device of claim 19, wherein the first predetermined temperature threshold value is smaller than the second predetermined temperature threshold value.
